(19) United States
(12) Patent Application Publication
(10) Pub. No.: US 2017/0215036 A1
(43) Pub. Date: Jul. 27, 2017

(54) Acquiring Global Positioning System (GPS) Information in Mobile Devices

(71) Applicant: QUALCOMM Incorporated, San Diego, CA (US)

(72) Inventors: Parthasarathy Krishnamoorthy, San Diego, CA (US); Chintan Shirish Shah, San Diego, CA (US); Reza Shahidi, San Diego, CA (US); Borislav Ristic, Del Mar, CA (US); Troy Curtiss, Boulder, CO (US); Suresh Kumar Bitra, Mangalagiri (IN); Ammar Kitabi, San Diego, CA (US); Vrutti Vyas, San Diego, CA (US); Jayesh Bathija, San Diego, CA (US); Pavan Kaivaram, San Diego, CA (US); Praveen Kumar Appani, San Diego, CA (US); Bhaskara Viswanadham Batchu, Hyderabad (IN)

(21) Appl. No.: 15/098,599

(22) Filed: Apr. 14, 2016

Related U.S. Application Data
(60) Provisional application No. 62/281,871, filed on Jan. 22, 2016.

(51) Int. Cl. H04W 4/02; H04W 52/02

(52) U.S. Cl. CPC H04W 4/023; H04W 4/02; H04W 52/0216; H04W 88/08

(57) ABSTRACT

Various examples include methods for assisting Global Positioning System (GPS) applications using a Long Term Evolution (LTE) subscription on a wireless communication device. Various example methods may include determining whether positioning information can be obtained from a first network associated with the LTE subscription, obtaining the positioning information from the first network through the LTE subscription in response to determining that the positioning information can be obtained from the first network, translating the positioning information into a format recognizable to a GPS application executing on the wireless communication device, and providing the positioning information to the GPS application.

### RELATED APPLICATIONS

This application claims the benefit of priority to U.S. Provisional Application No. 62/281,871 entitled “Acquiring Global Positioning System (GPS) Information in Mobile Devices” filed Jan. 22, 2016, the entire contents of which are incorporated herein by reference.

### BACKGROUND

Some designs of wireless communication devices—such as smart phones, tablet computers, and laptop computers—contain one or more Subscriber Identity Module (SIM) cards that provide users with access to multiple separate mobile telephony networks. Examples of mobile telephony networks include Third Generation (3G), Fourth Generation (4G), Long Term Evolution (LTE), Time Division Multiple Access (TDMA), Frequency Division Multiple Access (FDMA), Code Division Multiple Access (CDMA), Wideband CDMA (WCDMA), Time Division Synchronous CDMA (TD-SCDMA), Global System for Mobile Communications (GSM), Single-Carrier Radio Transmission Technology (1×RTT), and Universal Mobile Telecommunications Systems (UMTS).

A wireless communication device that includes one or more SIMs and connects to two or more separate mobile telephony networks supporting two or more subscriptions using one or more shared radio frequency (RF) resources/radios may be termed a multi-subscription, multi-standby (MSMS) communication device. One example of an Multi-SIM wireless communication device is a dual-SIM dual-standby (DSDS) communication device, which includes two SIM cards supporting two or more subscriptions that are each associated with a separate radio access technology (RAT). In DSDS communication devices, the separate subscriptions share one RF resource chain to communicate with two separate mobile telephony networks on behalf of their respective subscriptions. When one subscription is using the RF resource, the other subscription is in stand-by mode and is not able to communicate using the RF resource.

One consequence of wireless communication devices configured to support a plurality of SIMs/subscriptions that maintain network connections simultaneously is that the subscriptions may sometimes interfere with each other's communications. For example, two subscriptions on a DSDS communication device utilize a shared RF resource to communicate with their respective mobile telephony networks, and one subscription may use the RF resource to communicate with its mobile network at a time. Even when one or more subscriptions are in “idle-standby” mode, meaning that the subscriptions are not actively communicating with the network, the subscriptions may still need to periodically receive access to the shared RF resource in order to perform various network operations. For example, subscriptions may periodically perform a paging channel (PCH) or quick paging channel (QPCH) wake-up to check for paging messages sent by its respective network. QPCH wake-ups generally take a shorter amount of time than PCH wake-ups. If a subscription is currently active, the shared RF resource may be periodically tuned away from the active subscription to the idle subscription to perform the PCH or QPCH wake-up.

Global Positioning System (GPS) applications executing on a wireless communication device may utilize various types of positioning information to track the location of the wireless communication device. This positioning information may include time information, location information, and frequency error correction information for the crystal oscillator in the wireless communication device. The GPS application may be configured to obtain this positioning information from a subscription on the wireless communication device. For example, the GPS application may be synchronized with a GSM, CDMA, 1×RTT, or other single carrier (1×) network through an associated subscription on the wireless communication device. The GPS application may obtain the positioning information through a PCH wake-up on the subscription, which provides more information to the wireless communication device than a shorter QPCH wake-up. This positioning information may be used by the GPS application to aid in its location search for the wireless communication device.

### SUMMARY

Various examples include methods implemented on a wireless communication device for assisting Global Positioning System (GPS) applications using a Long Term Evolution (LTE) subscription. Various examples may include determining whether positioning information can be obtained from a first network associated with the LTE subscription, obtaining the positioning information from the first network through the LTE subscription in response to determining that the positioning information can be obtained from the first network, translating the positioning information into a format recognizable to a GPS application executing on the wireless communication device, and providing the positioning information to the GPS application.

In some examples, the positioning information may include at least one of time information, location information, and frequency error correction information. Some example methods may further include performing a tune-away to a second subscription on the wireless communication device to obtain positioning information from a second network associated with the second subscription in response to determining that the positioning information may not be obtained from the first network, and providing the positioning information obtained from the second network to the GPS application.

In some examples, determining whether positioning information can be obtained from the first network associated with the LTE subscription may include retrieving system information block (SIB) information from the first network, and determining whether the first network supports SIB-8 or SIB-16 formats from the SIB information. In some examples, the GPS application may utilize the positioning information to narrow a location search conducted by the GPS application. In some examples, the GPS application may not be configured to obtain the positioning information directly from the first network through the LTE subscription.

Further examples include a wireless communication device including a memory and a processor configured with processor-executable instructions to perform operations of the methods summarized above. Further examples include a non-transitory processor-readable storage medium having stored thereon processor-executable software instructions configured to cause a processor of a wireless communication device to perform operations of the methods summarized above. Further examples include a wireless communication device that includes means for performing functions of methods summarized above.

### BRIEF DESCRIPTION OF THE DRAWINGS

The accompanying drawings, which are incorporated herein and constitute part of this specification, illustrate aspects of various examples, and together with the general description and the detailed description given herein, serve to explain the features of the examples.

FIG. 1 is a communication system block diagram of a network suitable for use with various examples.

FIG. 2 is a block diagram illustrating a wireless communication device according to various examples.

FIG. 3 is a communication flow diagram illustrating conventional acquisition of positioning information for a GPS application on a wireless communication device.

FIG. 4 is a communication flow diagram illustrating acquisition of positioning information for a GPS application using a LTE subscription on a wireless communication device according to various examples.

FIG. 5 is a process flow diagram illustrating a method for assisting GPS applications using a LTE subscription on a wireless communication device according to various examples.

FIG. 6 is a component diagram of an example wireless communication device suitable for use with various examples.

### DETAILED DESCRIPTION

Various examples will be described in detail with reference to the accompanying drawings. Wherever possible, the same reference numbers will be used throughout the drawings to refer to the same or like parts. References made to particular examples and implementations are for illustrative purposes, and are not intended to limit the scope of the examples or the claims.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless communication device on a network and enable a communication service with the network. Because the information stored in a SIM enables the wireless communication device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or modem stack and communication processes used in establishing and conducting communication services with subscriptions and networks enabled by the information stored in a particular SIM.

As used herein, the term “multi-SIM wireless communication device” are used interchangeably to describe a wireless communication device that is configured to receive more than one SIM and support multiple subscriptions associated with the multiple SIMs.

The terms “network,” “wireless network,” “cellular network,” and “cellular wireless communication network” are used interchangeably herein to refer to a portion or all of a wireless network of a carrier associated with a wireless communication device and/or subscription on a wireless communication device.

In the following descriptions of various examples, references are made to a first subscription and a second subscription, and a first network and a second network. The references to the first and second subscriptions and first and second networks are arbitrary and are used merely for the purposes of describing the examples. The device processor may assign any indicator, name, or other designation to differentiate the subscriptions on the wireless communication device, and each subscription's respective network.

In the following descriptions of various examples, references are made to specific RATs associated with specific SIMs/subscriptions, such LTE, CDMA, GSM, 1×RTT, and 1× subscriptions. The references to LTE, CDMA, GSM, 1×RTT, and 1× are arbitrary and used merely for the purposes of describing the examples. SIMs/subscriptions in various examples may utilize a variety of RATs to communicate with a mobile telephony network, including but not limited to 3G, 4G, LTE, TDMA, CDMA, WCDMA, GSM, 1×RTT, and UMTS.

Modern wireless communication devices (e.g., smartphones) may be configured to accept multiple SIM cards containing SIMs that enable the same wireless communication device to connect to different mobile networks. Each SIM serves to identify and authenticate a subscriber using a particular wireless communication device, and each SIM is typically associated with only one subscription. For example, a SIM may be associated with a subscription to one of LTE, GSM, CDMA, UMTS or 1×RTT.

An MSMS wireless communication device, for example a DSDS device, may include multiple SIMs associated with multiple subscriptions that share an RF resource. The RF resource may include one or more receivers, transmitters, and/or transceivers and one or more antennas. When one subscription is active and utilizing the RF resource, the other subscriptions remain idle but may occasionally interrupt the active subscription to perform PCH or QPCH wake-ups.

GPS applications on the wireless communication device may be configured to obtain positioning information (e.g., time, location, and/or frequency error correction information) from certain RATs/subscriptions on a wireless communication device. For example, GPS applications may be configured to obtain positioning information from older or legacy RATs such as GSM, CDMA, 1×RTT, or other 1× technologies through PCH wake-ups.

GPS applications may not be configured to obtain positioning information from new or advanced types of RATs. For example, GPS applications may not be configured to obtain positioning information from 4G or LTE networks. On a multi-SIM wireless communication device with an LTE subscription and a 1× subscription, the LTE subscription may be on an active data call using the shared RF resource when a GPS application requests positioning information. The shared RF resource may be tuned away from the LTE subscription to the 1× subscription to obtain the positioning information using a PCH wake-up. This may result in a disruption to the active data call on the LTE subscription, longer than the disruption caused by a QPCH wake-up if no positioning information is used. In addition, the longer wake-up duration also results in increased power consumption.

In a multi-SIM wireless communication device in which a LTE subscription is currently active, a GPS application may request positioning information from an idle subscription (e.g., GSM, CDMA, 1×RTT). The wireless communication device may perform a tune-away from the active LTE subscription to the idle subscription using a PCH wake-up. This allows the positioning information to be obtained from the idle subscription. However, the active call on the LTE subscription is disrupted for a long period of time during the PCH wake-up. In addition, more power is consumed performing the PCH wake-up than if a shorter QPCH wake-up was performed.

Systems, methods, and devices of various examples enable a wireless communication device to assist GPS applications using a LTE subscription on the wireless communication device. A processor of the wireless communication device may determine whether positioning information can be obtained from a first network associated with the LTE subscription. For example, the processor may retrieve system information block (SIB) information from the first network and determine whether the first network supports SIB-8 or SIB-16 formats from the SIB information. The SIB-8 or SIB-16 formats may provide the positioning information that can be used by a GPS application, which may include at least one of time information, location information, and frequency error correction information.

The processor may obtain the positioning information from the first network through the LTE subscription in response to determining that the positioning information can be obtained from the first network. The processor may translate the positioning information obtained from the LTE subscription into a format recognizable to the GPS application and then provide the translated positioning information to the GPS application. The GPS application may utilize the positioning information to narrow a location search conducted by the GPS application.

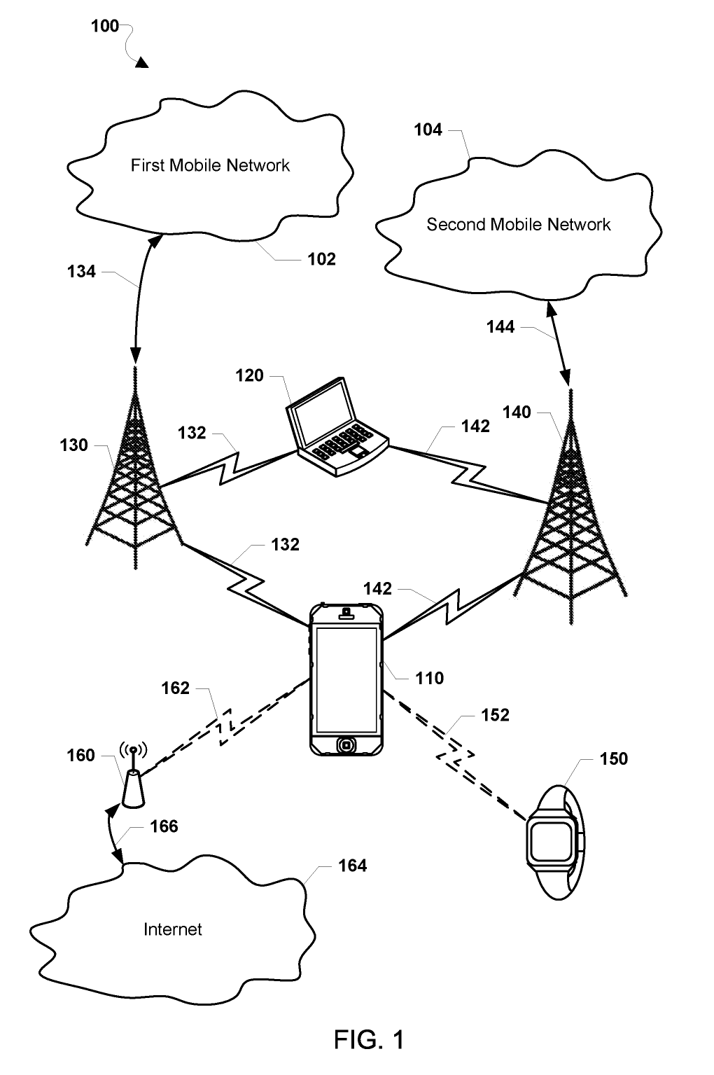

Various examples may be implemented within a variety of communication systems 100, such as at least two mobile telephony networks, an example of which is illustrated in FIG. 1. A first mobile network 102 and a second mobile network 104 typically each include a plurality of cellular base stations (e.g., a first base station 130 and a second base station 140). A first wireless communication device 110 may be in communication with the first mobile network 102 through a cellular connection 132 to the first base station 130. The first wireless communication device 110 may also be in communication with the second mobile network 104 through a cellular connection 142 to the second base station 140. The first base station 130 may be in communication with the first mobile network 102 over a wired connection 134. The second base station 140 may be in communication with the second mobile network 104 over a wired connection 144.

A second wireless communication device 120 may similarly communicate with the first mobile network 102 through the cellular connection 132 to the first base station 130. The second wireless communication device 120 may also communicate with the second mobile network 104 through the cellular connection 142 to the second base station 140. The cellular connections 132 and 142 may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), Universal Mobile Telecommunications Systems (UMTS), and other mobile telephony communication technologies.

While the wireless communication devices 110, 120 are shown connected to the first mobile network 102 and, optionally, to the second mobile network 104, in some examples (not shown), the wireless communication devices 110, 120 may include two or more subscriptions to two or more mobile networks and may connect to those subscriptions in a manner similar to those described herein.

In some examples, the first wireless communication device 110 may optionally establish a wireless connection 152 with a peripheral device 150 used in connection with the first wireless communication device 110. For example, the first wireless communication device 110 may communicate over a Bluetooth® link with a Bluetooth-enabled personal computing device (e.g., a “smart watch”). In some examples, the first wireless communication device 110 may optionally establish a wireless connection 162 with a wireless access point 160, such as over a Wi-Fi connection. The wireless access point 160 may be configured to connect to the Internet 164 or another network over a wired connection 166.

While not illustrated, the second wireless communication device 120 may similarly be configured to connect with the peripheral device 150 and/or the wireless access point 160 over wireless links.

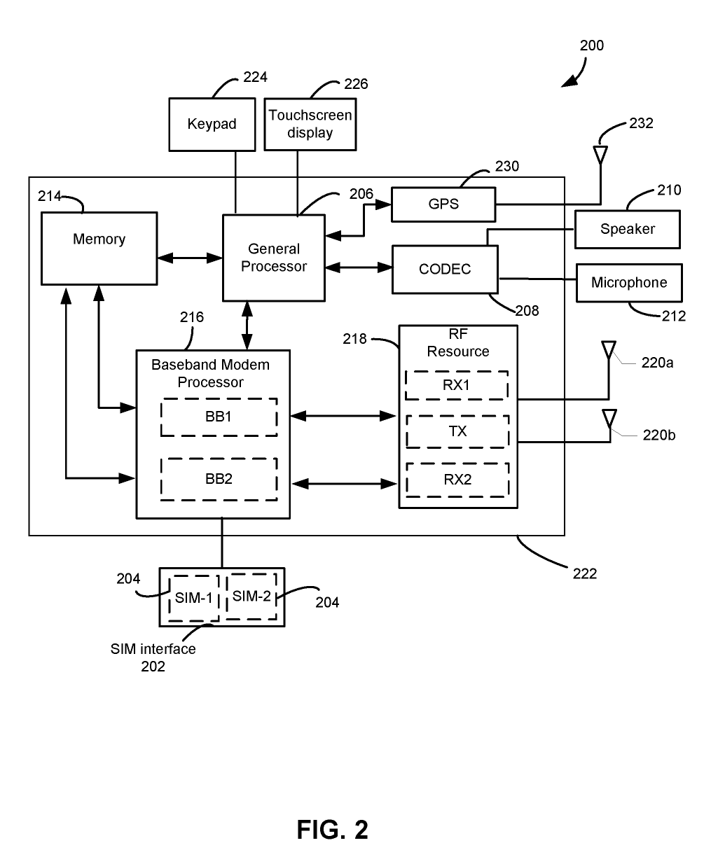

FIG. 2 is a functional block diagram of an example multi-SIM wireless communication device 200 that is suitable for implementing various examples. With reference to FIGS. 1-2, the multi-SIM wireless communication device 200 may be similar to one or more of the wireless communication devices 102. The multi-SIM wireless communication device 200 may include a SIM interface 202, which may represent either one or two SIM interfaces. The SIM interface 202 may receive a first identity module SIM 204 that is associated with the first subscription. In some examples, the multi-SIM wireless communication device 200 may also include a second SIM interface as part of the SIM interface 202, which may receive a second identity module SIM 204 that is associated with a second subscription.

A SIM in various examples may be a Universal Integrated Circuit Card (UICC) that is configured with SIM and/or Universal SIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204 may have a central processing unit (CPU), read only memory (ROM), random access memory (RAM), electrically erasable programmable read only memory (EEPROM) and input/output (I/O) circuits. A SIM 204 used in various examples may contain user account information, an IMSI a set of SIM application toolkit (SAT) commands and storage space for phone book contacts. A SIM 204 may further store home identifiers (e.g., a System Identification Number (SID)/Network Identification Number (NID) pair, a Home Public Land Mobile Number (HPLMN) code, etc.) to indicate the SIM network operator provider. An Integrated Circuit Card Identity (ICCID) SIM serial number may be printed on the SIM card for identification.

The multi-SIM wireless communication device 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions. The memory 214 may also store quality metrics for various channels supported by the SIMs 204 and the RF resource 218.

The general purpose processor 206 and memory 214 may each be coupled to at least one baseband-modem processor 216. Each SIM 204 in the multi-SIM wireless communication device 200 may be associated with a baseband-RF resource chain that includes a baseband-modem processor 216 and at least one receive block (e.g., RX1, RX2) of an RF resource 218. In various examples, baseband-RF resource chains may include physically or logically separate baseband modem processors (e.g., BB1, BB2).

The RF resource 218 may be coupled to antennas 220a, 220b, and may perform transmit/receive functions for the wireless services associated with each SIM 204 of the multi-SIM wireless communication device 200. In some examples, the RF resource 218 may be coupled to wireless antennas 220a, 220b for sending and receiving RF signals for multiple SIMs 204 thereby enabling the multi-SIM wireless communication device 200 to perform simultaneous communications with separate networks and/or service associated with the SIM(s) 204. The RF resource 218 may include separate receive and transmit functionalities, or the RF resource 218 may include a transceiver that combines transmitter and receiver functions. In various examples, the transmit functionalities of the RF resource 218 may be implemented by at least one transmit block (TX), which may represent circuitry associated with one or more radio access technologies/SIMs

In some examples, the general purpose processor 206, memory 214, baseband-modem processor(s) 216, and RF resource 218 may be included in a system-on-chip device 222. The one or more SIM 204 and corresponding interface(s) 202 may be external to the system-on-chip device 222. Further, various input and output devices may be coupled to components of the system-on-chip device 222, such as interfaces or controllers. Example user input components suitable for use in the multi-SIM wireless communication device 200 may include, but are not limited to, a keypad 224, and a touch screen display 226.

In some examples, the keypad 224, touch screen display 226, microphone 212, or a combination thereof, may perform the function of receiving the request to initiate an outgoing call. For example, the touch screen display 226 may receive a selection of a contact from a contact list or receive a telephone number. In another example, either or both of the touch screen display 226 and microphone 212 may perform the function of receiving a request to initiate an outgoing call. For example, the touch screen display 226 may receive selection of a contact from a contact list or receive a telephone number. As another example, the request to initiate the outgoing call may be in the form of a voice command received via the microphone 212. Interfaces may be provided between the various software units and functions in the multi-SIM wireless communication device 200 to enable communication between them, as is known in the art.

The multi-SIM wireless communication device 200 may also include a GPS receiver 230 coupled to the processor 206. The GPS receiver 230 may be implemented in hardware and/or software. The GPS receiver 230 may be coupled to an antenna 232 for receiving signals from GPS satellites. Alternatively, the GPS receiver 230 may receive signals from GPS satellites via an antenna 220a, 220b. The GPS receiver 230 may include memory and a processor that implements a GPS application and/or that is configured to interface with GPS application implemented within the processor 206. The GPS receiver 230 may be configured to receive timing and positioning information from a wireless network via the RF resource 218.

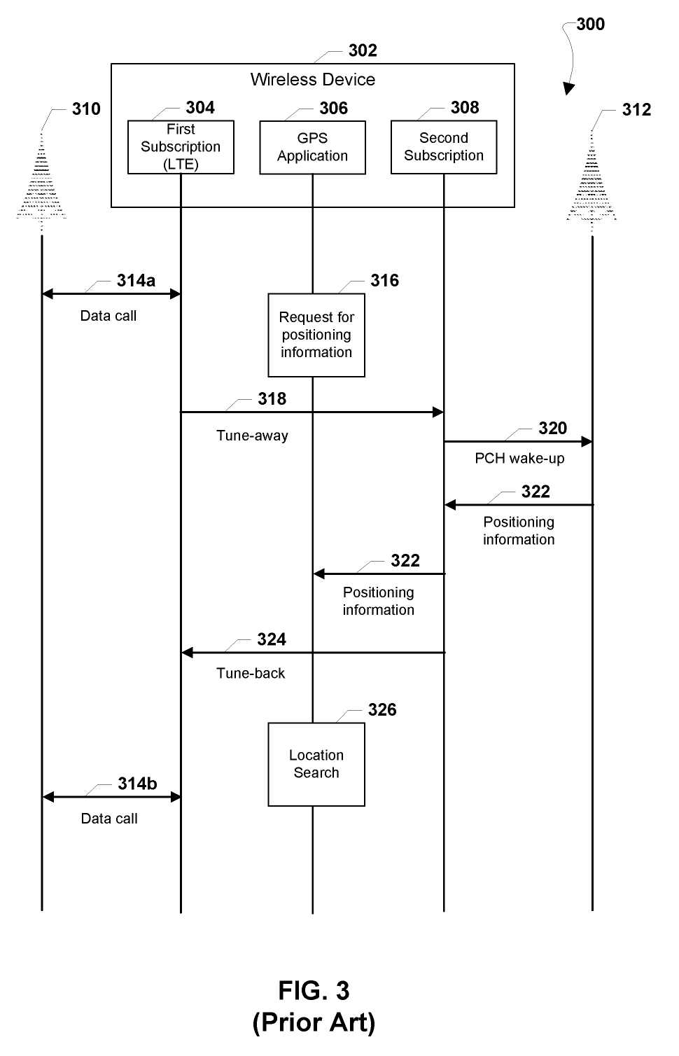

FIG. 3 is a communication flow diagram 300 illustrating conventional acquisition of positioning information for a GPS application on a wireless communication device 302. With reference to FIGS. 1-3, the wireless communication device 302 may be a Multi-SIM wireless communication device, for example a DSDS device, with a first subscription 304 and a second subscription 308 sharing an RF resource. The first subscription 304 may be a LTE subscription. The second subscription 308 may be a GSM, CDMA, 1×RTT, or other 1× subscription. The first subscription 304 may be associated with a first network 310, while the second subscription 308 may be associated with a second network 312. The wireless communication device 302 may also include a GPS application 306. The GPS application 306 may be, for example, a navigation or mapping application, a social media application, or any other application or program that includes GPS capability. The wireless communication device 302 may also include the GPS receiver 230 implemented in hardware and/or software and configured with or to communicate with the GPS application 306.

The first subscription 304 may be engaged in an active data call 314a with the first network 310. The first subscription 304 may periodically perform tune-aways to the second subscription 308 so that the second subscription 308 may perform idle mode operations such as paging wake-ups. For example, the second subscription 308 may periodically perform QPCH wake-ups to check for paging messages.

During the data call 314a, the GPS application 306 may request positioning information from the second subscription 308 in operation 316. For example, the GPS application 306 may be initiated by a user of the wireless communication device 302 and conducts an initial location search to determine the location of the wireless communication device 302. The GPS application 306 may be configured to obtain positioning information from the second subscription 308 (e.g., a GSM, CDMA, 1×RTT, or another legacy subscription) but the GPS application may not be configured to obtain positioning information from the first subscription 304 (e.g., the LTE subscription).

The wireless communication device 302 may perform a tune-away 318 from the first subscription 304 to the second subscription 308 (i.e., give control of the shared RF resource to the second subscription 308). During the tune-away 318 the data call 314a is suspended, and the second subscription 308 may initiate a PCH wake-up 320 to obtain paging message information from the second network 312, as well as receive positioning information 322. However, the positioning information 322 may not be able to be obtained through shorter QPCH wake-ups because the second network 312 does not send the positioning information 322 (i.e., the information that can be used by a GPS application) during a QPCH wake-up.

The positioning information 322 may include time or time transfer information, such as the current time as maintained by the second network 312. The positioning information 322 may also include location information of the wireless communication device 302, for example through advanced forward link trilateration provided by the second network 312. The positioning information 322 may also include frequency error correction information, or rotator error information, that the GPS application can use to correct for errors in the frequency of the crystal oscillator in the wireless communication device 302.

The positioning information 322 may be passed to the GPS application 306. At the conclusion of the tune-away 318, the wireless communication device 302 may conduct a tune-back 324 in order to give the first subscription 304 control of the shared RF resource. The first subscription 304 may then resume the data call 314b. Meanwhile, the GPS application 306 may use the positioning information 322 to narrow the location search 326 for the location of the wireless communication device 302.

During the tune-away 318 prior to the tune-back 324, the data call 314a on the first subscription 304 is interrupted. Interrupting the data call 314a for the tune-away 318 while the second subscription 308 performs the PCH wake-up 320 to obtain the positioning information 322 may result in reduced data throughput on the first subscription 304. Because the positioning information 322 can only be obtained through a PCH wake-up and not a shorter QPCH wake-up, there is more disruption to the first subscription 304, as well as increased power consumption.

The systems and methods of various examples disclose a way for GPS applications to obtain positioning information from certain subscriptions (e.g., LTE) even though the GPS applications may not be configured to synchronize with those subscriptions. For example, GPS applications may not be configured to obtain positioning information from new or advanced RATs such as 4G or LTE even though the positioning information is available through those RATs. However, the wireless communication device may be configured to translate between the GPS application and subscriptions that the GPS application is not configured to connect with automatically.

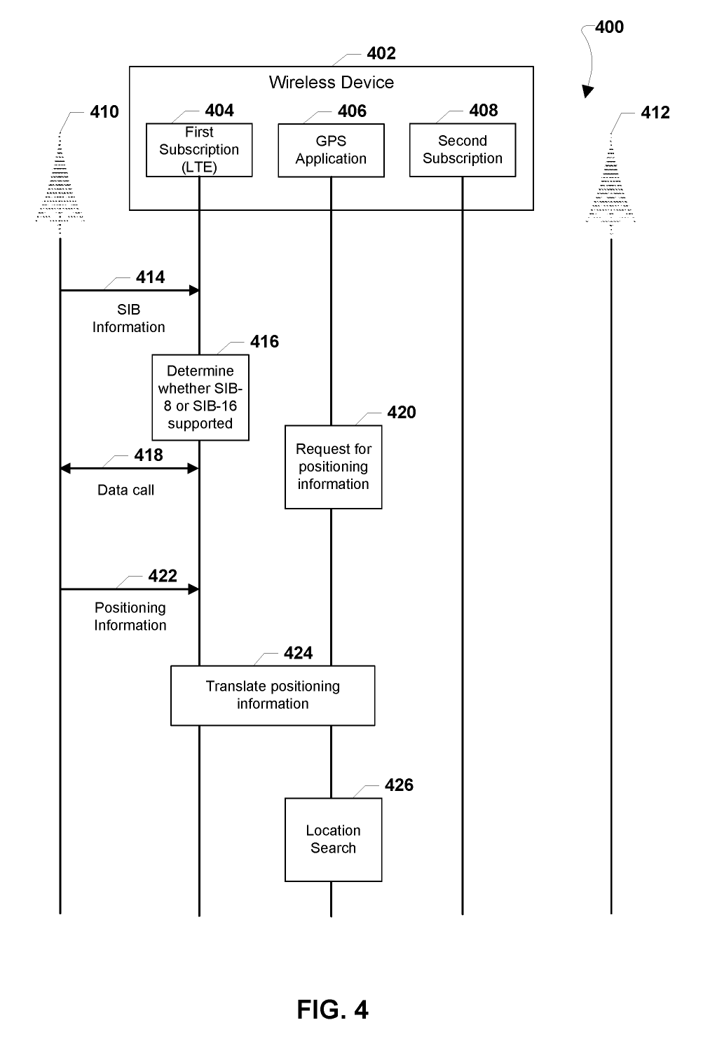

FIG. 4 is a communication flow diagram 400 illustrating acquisition of positioning information for a GPS application on a wireless communication device 402 according to various examples. With reference to FIGS. 1-4, the wireless communication device 402 may be a multi-SIM wireless communication device, for example a DSDS device, with a first subscription 404 and a second subscription 408 sharing an RF resource. The first subscription 404 may be an LTE subscription. The second subscription 408 may be a GSM, CDMA, 1×RTT, or other 1× subscription. The first subscription 404 may be associated with a first network 410, while the second subscription 408 may be associated with a second network 412. In alternative examples, the wireless communication device 402 may be a single SIM device supporting only one (i.e., the first) subscription 404.

The wireless communication device 402 may be configured with a GPS application 406. The GPS application 406 may be, for example, a navigation or mapping application, a social media application, or any other application or program that includes GPS capability. The GPS application 406 may be configured to obtain positioning information from the second subscription 408 (e.g., a GSM, CDMA, 1×RTT, or another legacy subscription); however, the GPS application 406 may not be configured to obtain positioning information from the first subscription 404 (e.g., the LTE subscription). The wireless communication device 402 may also include a GPS receiver 230 implemented in hardware and/or software and configure with or configured to interface with the GPS application 406.

The wireless communication device 402 may receive SIB information 414 from the first network 410, for example when attaching to the first network 410 to receive service. The SIB information 414 may be used to determine whether the first network 410 is capable of providing the positioning information that can be used by the GPS application 406 in operation 416. For example, the wireless communication device 402 may determine whether the first network 410 supports the SIB-8 or SIB-16 formats by reading certain variables (e.g., “si_Periodicity” or “sib_MappingInfo”) from the SIB information 414. The SIB-8 and SIB-16 formats may provide positioning information that may be used by the GPS application 406. If the first network 410 does not support SIB-8 or SIB-16 formats, the wireless communication device 402 may perform a tune-away to the second network 412 to obtain the positioning information (i.e., return to the operations illustrated in the communication flow diagram 300).

After attaching to the first network 410 and determining the supported SIB formats, the first subscription 404 may engage in an active data call 418 with the first network 410. At some point after it is determined that the first network 410 can provide positioning information for the GPS application 406, the GPS application 406 may request such positioning information in operation 420. For example, the GPS application 406 may be initiated by a user of the wireless communication device 402 and conducts an initial location search to determine the location of the wireless communication device 402.

The wireless communication device 402 may obtain positioning information 422 from the first network 410 through the first subscription 404 rather than performing a tune-away to the second subscription 408 to obtain the positioning information from the second network 412. Specifically, the positioning information 422 may be received within periodic SIB transmissions from the first network 410. The positioning information 422 may include time or time transfer information, such as the current time as maintained by the first network 410. The positioning information 422 may also include location information of the wireless communication device 402, for example through position reference signals (PRS) (e.g., LTE-PRS signals) as provided by the first network 410. The positioning information 422 may also include frequency error correction information, or rotator error information, to correct for errors in the frequency of the crystal oscillator in the wireless communication device 402.

The wireless communication device 402 may translate the positioning information 422 into a format recognizable by the GPS application 406 in operation 424. The positioning information 422 may be received in a format that cannot be processed by the GPS application 406. For example, the GPS application 406 may be configured to receive information directly from the second network 412, but not from the first network 410. A translator unit or software in the wireless communication device 402, such as the GPS receiver 230, may alter the formatting, language, or other attributes of the positioning information 422 such that the GPS application 406 may read and process the positioning information 422. The GPS application 406 may use the translated positioning information 422 to narrow the location search 426 for the location of the wireless communication device 402.

Thus, a wireless communication device 402 implementing various examples enables the wireless communication device 402 to obtain the positioning information 422 from the first network 410, rather than the second network 412. As a result, the wireless communication device 402 is able to support the GPS application 406 without disrupting a data call 418 on the first subscription 404 to perform a tune-away. The method 400 may also lower power consumption on the wireless communication device 402.

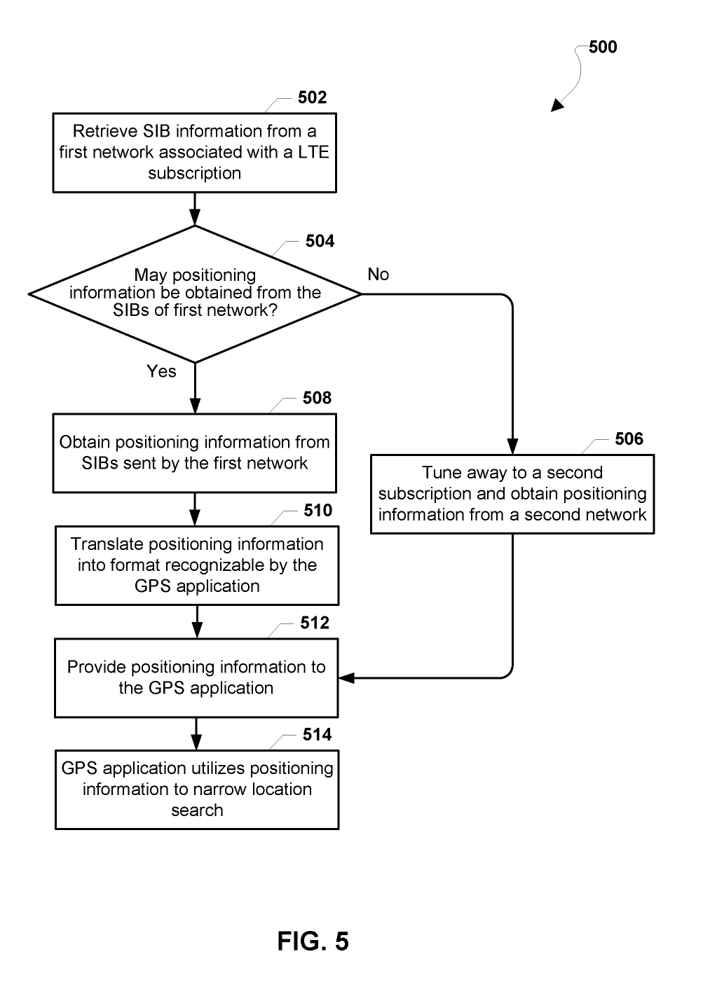

FIG. 5 illustrates a method 500 for assisting GPS applications using a LTE subscription on a wireless communication device according to various examples. With reference to FIGS. 1-5, the operations of the method 500 may be implemented by one or more processors of the multi-SIM wireless communication device 200, such as a general purpose processor 206, a baseband modem processor(s) 216, or a separate controller (not shown) that may be coupled to the memory 214 and to the baseband modem processor(s) 216. The wireless communication device may be a multi-SIM wireless communication device, for example a DSDS device with a first subscription (e.g., LTE) and a second subscription (e.g., GSM, CDMA, 1×RTT) sharing an RF resource. Alternatively, the wireless communication device may be a single SIM device with a LTE subscription.

In block 502, the processor may retrieve SIB information from a first network (e.g., a LTE network) associated with the first subscription. The SIB information may be retrieved when the first subscription attaches to the first network for service.

In determination block 504, the processor may determine whether positioning information can be obtained from the SIBs of the first network. For example, the processor may read certain variables (e.g., “si_Periodicity” or “sib_MappingInfo”) from the retrieved SIB information and determine whether the first network supports the SIB-8 or SIB-16 formats. These formats may provide positioning information usable to a GPS application on the wireless communication device. The GPS application may be configured to receive positioning information from a second network associated with the second subscription but not the first network.

In response to determining that the positioning information may not be obtained from the SIBs of the first network (i.e., determination block 504=“No”), the processor may perform a tune-away from the first subscription to the second subscription and obtain the positioning information from the second network in block 506. In other words, upon determining that the first subscription (e.g., the LTE subscription) cannot support GPS functions, the processor may fall back to obtaining the positioning information from the second subscription.

In response to determining that the positioning information can be obtained from the SIBs of the first network (i.e., determination block 504=“Yes”), the processor may obtain positioning information from SIBs sent by the first network in block 508. For example, the SIBs may include time or time transfer information, such as the current time as maintained by the first network. The SIBs may also include location information of the wireless communication device, for example through LTE-PRS signals as provided by the first network. The SIBs may also include frequency error correction information, or rotator error information, that the GPS application can use to correct for errors in the frequency of the crystal oscillator in the wireless communication device.

In block 510, the processor may translate the obtained positioning information into a format recognizable by the GPS application. A translator unit or software in the wireless communication device, for example the GPS receiver 230, may alter the formatting, language, or other attributes of the positioning information such that the GPS application may read and process the positioning information.

In block 512, the processor may provide the translated positioning information (if obtained from the first network) or un-translated positioning information (if obtained from the second network) to the GPS application. In block 514, the GPS application may use the positioning information to initiate or narrow a location search conducted by the GPS application to locate the wireless communication device. Thus, the method 500 provides a way for GPS applications to obtain positioning information from certain RATs from which the GPS applications are not normally configured to obtain positioning information.

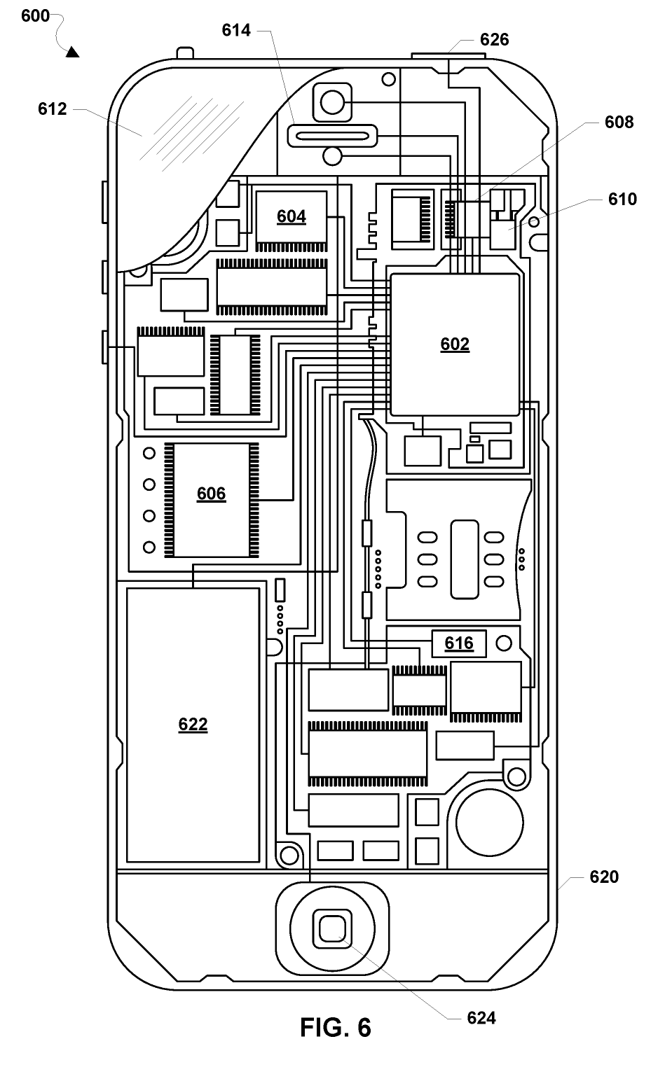

Various examples may be implemented in any of a variety of wireless communication devices, an example of which (e.g., wireless communication device 600) is illustrated in FIG. 6. According to various examples, the wireless communication device 600 may be similar to the wireless communication devices 110, 120, 402 as described with reference to FIGS. 1 and 4, as well as multi-SIM wireless communication device 200 as described with reference to FIG. 2. As such, the wireless communication device 600 may implement the method 500 in FIG. 5.

With reference to FIGS. 1-6, the wireless communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the wireless communication device 600 need not have touch screen capability.

The wireless communication device 600 may have one or more cellular network transceivers 608 coupled to the processor 602 and to one or more antennas 610 and configured for sending and receiving cellular communications. The one or more transceivers 608 and the one or more antennas 610 may be used with the herein-mentioned circuitry to implement methods according to various examples. The wireless communication device 600 may include one or more SIM cards 616 coupled to the one or more transceivers 608 and/or the processor 602 and may be configured as described herein.

The wireless communication device 600 may also include speakers 614 for providing audio outputs. The wireless communication device 600 may also include a housing 620, constructed of a plastic, metal, or a combination of materials, for containing all or some of the components discussed herein. The wireless communication device 600 may include a power source 622 coupled to the processor 602, such as a disposable or rechargeable battery. The rechargeable battery may also be coupled to the peripheral device connection port to receive a charging current from a source external to the wireless communication device 600. The wireless communication device 600 may also include a physical button 624 for receiving user inputs. The wireless communication device 600 may also include a power button 626 for turning the wireless communication device 600 on and off.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the operations of various examples must be performed in the order presented. As will be appreciated by one of skill in the art the order of operations in the foregoing examples may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit various examples to a particular order, sequence, type of network or carrier.

The various illustrative logical blocks, units, circuits, and algorithm operations described in connection with the examples disclosed herein may be implemented as electronic hardware, computer software, or combinations of both. To clearly illustrate this interchangeability of hardware and software, various illustrative components, blocks, units, circuits, and operations have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present examples.

The hardware used to implement the various illustrative logics, logical blocks, units, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software unit, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, compact disc read only memory (CD-ROM) or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc in which disks usually reproduce data magnetically, while discs reproduce data optically with lasers. Combinations of the storage media are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed examples is provided to enable any person skilled in the art to make or use the claims. Various modifications to these examples will be readily apparent to those skilled in the art, and the generic principles defined herein may be applied to other examples without departing from the scope of the claims. Thus, the present disclosure is not intended to be limited to the examples shown herein but is to be accorded the widest scope consistent with the following claims and the principles and novel features disclosed herein.

What is claimed is:

1. A method for assisting Global Positioning System (GPS) applications using a Long Term Evolution (LTE) subscription on a wireless communication device, comprising:
determining whether positioning information can be obtained from a first network associated with the LTE subscription;
obtaining the positioning information from the first network through the LTE subscription in response to determining that the positioning information can be obtained from the first network;
translating the positioning information into a format recognizable to a GPS application executing on the wireless communication device; and
providing the positioning information to the GPS application.

2. The method of claim 1, wherein the positioning information includes at least one of time information, location information, and frequency error correction information.

3. The method of claim 1, further comprising:
performing a tune-away to a second subscription on the wireless communication device to obtain positioning information from a second network associated with the second subscription in response to determining that the positioning information may not be obtained from the first network; and
providing the positioning information obtained from the second network to the GPS application.

4. The method of claim 1, wherein determining whether positioning information can be obtained from the first network associated with the LTE subscription comprises:
retrieving system information block (SIB) information from the first network; and
determining whether the first network supports SIB-8 or SIB-16 formats from the SIB information.

5. The method of claim 1, wherein the GPS application utilizes the positioning information to narrow a location search conducted by the GPS application.

6. The method of claim 1, wherein the GPS application is not configured to obtain the positioning information directly from the first network through the LTE subscription.

7. A wireless communication device, comprising:
a memory;
a first subscriber identity module (SIM) associated with a Long Term Evolution (LTE) subscription;
a radio frequency (RF) resource; and
a processor coupled to the memory, the first SIM and the RF resource, and configured to:
determine whether positioning information can be obtained from a first network associated with the LTE subscription;
obtain the positioning information from the first network through the LTE subscription in response to determining that the positioning information can be obtained from the first network;
translate the positioning information into a format recognizable to a GPS application executing on the wireless communication device; and
provide the positioning information to the GPS application.

8. The wireless communication device of claim 7, wherein the positioning information includes at least one of time information, location information, and frequency error correction information.

9. The wireless communication device of claim 7, further comprising a second SIM associated with a second subscription, wherein the processor is coupled to the second SIM and further configured to:
perform a tune-away to the second subscription to obtain positioning information from a second network associated with the second subscription in response to determining that the positioning information may not be obtained from the first network; and
provide the positioning information obtained from the second network to the GPS application.

10. The wireless communication device of claim 7, wherein the processor is further configured to determine whether positioning information can be obtained from the first network associated with the LTE subscription by:
retrieving system information block (SIB) information from the first network; and
determining whether the first network supports SIB-8 or SIB-16 formats from the SIB information.

11. The wireless communication device of claim 7, wherein the GPS application utilizes the positioning information to narrow a location search conducted by the GPS application.

12. The wireless communication device of claim 7, wherein the GPS application is not configured to obtain the positioning information directly from the first network through the LTE subscription.

13. A non-transitory computer readable storage medium having stored thereon processor-executable software instructions configured to cause a processor of a wireless communication device to perform operations comprising:
determining whether positioning information can be obtained from a first network associated with the a Long Term Evolution (LTE) subscription on the wireless communication device;
obtaining the positioning information from the first network through the LTE subscription in response to determining that the positioning information can be obtained from the first network;
translating the positioning information into a format recognizable to a GPS application executing on the wireless communication device; and
providing the positioning information to the GPS application.

14. The non-transitory computer readable storage medium of claim 13, wherein the positioning information includes at least one of time information, location information, and frequency error correction information.

15. The non-transitory computer readable storage medium of claim 13, wherein the stored processor-executable software instructions are configured to cause the processor to perform operations further comprising:
performing a tune-away to a second subscription on the wireless communication device to obtain positioning information from a second network associated with the second subscription in response to determining that the positioning information may not be obtained from the first network; and
providing the positioning information obtained from the second network to the GPS application.

16. The non-transitory computer readable storage medium of claim 13, wherein the stored processor-executable software instructions are configured to cause the processor to perform operations such that determining whether positioning information can be obtained from the first network associated with the LTE subscription comprises:
retrieving system information block (SIB) information from the first network; and
determining whether the first network supports SIB-8 or SIB-16 formats from the SIB information.

17. The non-transitory computer readable storage medium of claim 13, wherein the GPS application utilizes the positioning information to narrow a location search conducted by the GPS application.

18. The non-transitory computer readable storage medium of claim 13, wherein the GPS application is not configured to obtain the positioning information directly from the first network through the LTE subscription.

19. A wireless communication device, comprising:
means for determining whether positioning information can be obtained from a first network associated with a Long Term Evolution (LTE) subscription on the wireless communication device;
means for obtaining the positioning information from the first network through the LTE subscription in response to determining that the positioning information can be obtained from the first network;
means for translating the positioning information into a format recognizable to a GPS application executing on the wireless communication device; and
means for providing the positioning information to the GPS application.

20. The wireless communication device of claim 19, wherein the positioning information includes at least one of time information, location information, and frequency error correction information.

21. The wireless communication device of claim 19, further comprising:
means for performing a tune-away to a second subscription on the wireless communication device to obtain positioning information from a second network associated with the second subscription in response to determining that the positioning information may not be obtained from the first network; and
means for providing the positioning information obtained from the second network to the GPS application.

22. The wireless communication device of claim 19, wherein means for determining whether positioning information can be obtained from the first network associated with the LTE subscription comprises:
means for retrieving system information block (SIB) information from the first network; and
means for determining whether the first network supports SIB-8 or SIB-16 formats from the SIB information.

23. The wireless communication device of claim 19, wherein the GPS application utilizes the positioning information to narrow a location search conducted by the GPS application.

24. The wireless communication device of claim 19, wherein the GPS application is not configured to obtain the positioning information directly from the first network through the LTE subscription.
